(19) United States
(12) Patent Application Publication
(10) Pub. No.: US 2025/0095877 A1
(43) Pub. Date: Mar. 20, 2025

(54) CABLE

(71) Applicants: SUMITOMO ELECTRIC INDUSTRIES, LTD., Osaka (JP); AutoNetworks Technologies, Ltd., Mie (JP); Sumitomo Wiring Systems, Ltd., Mie (JP)

(72) Inventors: Takumi OOSHIMA, Tochigi (JP); Hirokazu KOMORI, Osaka (JP); Takahiro MURATA, Mie (JP)

(21) Appl. No.: 18/832,689

(22) PCT Filed: Feb. 17, 2022
(86) PCT No.: PCT/JP2022/006429

§ 371 Date: Jul. 24, 2024

(51) Int. Cl. H01B 7/02; H01B 7/04; H01B 7/18

(52) U.S. Cl. CPC H01B 7/0216; H01B 7/04; H01B 7/1875

(57) ABSTRACT

A cable includes a plurality of coated electric wires and a sheath covering the plurality of coated electric wires, wherein the sheath includes a first sheath and a second sheath in order from an outer surface side, and wherein the second sheath has a smaller elastic modulus than the first sheath.

### TECHNICAL FIELD

The present disclosure relates to cables.

### BACKGROUND ART

Patent Document 1 discloses a bundled cable that includes an electric wire bundle and an outer sheath covering the electric wire bundle. The electric wire bundle includes a first electric wire of one core, a second electric wire of one core, a twisted-pair electric wire of two cores, a third electric wire of one core, and a linear interposition formed from a polymer wire. In a cross-sectional view of the electric wire bundle, the twisted-pair electric wire is arranged on one side of the center line connecting the center of the first electric wire and the center of the second electric wire, and the third electric wire and the linear interposition are arranged on the other side of the center line.

### RELATED ART DOCUMENT

### Patent Document

[Patent document 1] International Publication No. 2020/111162

### SUMMARY OF INVENTION

A cable of the present disclosure includes a plurality of coated electric wires and a sheath covering the plurality of coated electric wires, wherein the sheath includes a first sheath and a second sheath in order from an outer surface side, and wherein the second sheath has a smaller elastic modulus than the first sheath.

### BRIEF DESCRIPTION OF DRAWINGS

FIG. 1 is a cross-sectional view of a cable according to one aspect of the present disclosure in a plane perpendicular to the longitudinal direction.

FIG. 2 is a cross-sectional view of a cable according to one aspect of the present disclosure in a plane perpendicular to the longitudinal direction.

FIG. 3 is a cross-sectional view of a cable according to one aspect of the present disclosure in a plane perpendicular to the longitudinal direction.

FIG. 4 is a cross-sectional view of a cable according to one aspect of the present disclosure in a plane perpendicular to the longitudinal direction.

FIG. 5 is a cross-sectional view of a cable according to one aspect of the present disclosure in a plane perpendicular to the longitudinal direction.

FIG. 6 is a cross-sectional view of a cable according to one aspect of the present disclosure in a plane perpendicular to the longitudinal direction.

FIG. 7A is an illustrative view of a cable according to one aspect of the present disclosure when fixed by a fixture.

FIG. 7B is an illustrative view of the cable according to one aspect of the present disclosure when fixed by the fixture.

FIG. 8 is an illustrative view of a flex-life test.

### MODE FOR CARRYING OUT THE INVENTION

### Problems to be Solved by the Present Disclosure

A cable mounted on an automobile is fixed to the vehicle at several locations. Depending on where the cable is wired, the cable may be repeatedly bent at the points where the cable is fixed. When the cable is bent, force is concentrated at the fixed points of the cable, which may result in the breaking of the cable.

In consideration of the above, there has been a need for a cable containing a plurality of coated electric wires for which breakage is less likely even when repeatedly bent.

An object of the present disclosure is to provide a cable that suppresses wire breakage even when repeatedly bent.

### Advantageous Effect of the Present Disclosure

According to the present disclosure, it is possible to provide a cable capable of suppressing wire breakage even when repeatedly bent.

The embodiments will now be described below.

### DESCRIPTION OF EMBODIMENTS OF THE PRESENT DISCLOSURE

Embodiments of the present disclosure will first be listed and described. In the following description, the same or corresponding elements will be referred to by the same reference numerals, and duplicate descriptions thereof will not be given.
(1) A cable according to one aspect of the present disclosure includes a plurality of coated electric wires and a sheath covering the plurality of coated electric wires, wherein the sheath includes a first sheath and a second sheath in this order from the outer surface side, and wherein the second sheath has a smaller elastic modulus than the first sheath.
By making the elastic modulus of the second sheath located on the inner perimeter side of the sheath smaller than that of the first sheath located on the outer perimeter side, the second sheath can deform and absorb the force even when the cable is subjected to force and repeatedly flexed. This arrangement reduces the force applied to the plurality of coated electric wires by bending, and suppresses the breakage of the coated electric wires even when the cable is repeatedly bent.
The sheath has the function to protect the coated electric wires inside the cable. The sheath includes at least two layers, i.e., the first sheath and the second sheath, as described above, and the second sheath functions as a layer for absorbing the force applied to the cable, thereby allowing the elastic modulus of the first sheath to be increased to enhance the mechanical strength of the cable. Cables wired to automobiles are required to have abrasion resistance against abrasion with the vehicle body, scratch resistance that prevents scratching even when hit by stepping stones, etc., and bending resistance that ensures less deterioration even when repeatedly bent. These requirements can be met by increasing the mechanical strength of the sheath.
(2) The elastic modulus of the second sheath may be from 40% to 80% of the elastic modulus of the first sheath.
Setting the elastic modulus of the second sheath to 80% or less of the elastic modulus of the first sheath allows the cable to possess increased flexibility. When the cable is subjected to force and repeatedly bent, thus, the force applied to the cable can be absorbed, which prevents the coated electric wire from breaking.
Setting the elastic modulus of the second sheath to be 40% or more of the elastic modulus of the first sheath allows the second sheath to be produced by extrusion molding. This allows the productivity of the cable to be increased and the cost to be reduced.
(3) The first sheath may have an elastic modulus of 33 MPa to 55 MPa.
Setting the elastic modulus of the first sheath to 55 MPa or less allows the cable to possess flexibility suitable for wiring in an automobile. Setting the elastic modulus of the first sheath to 33 MPa or more allows the mechanical strength of the first sheath to be sufficiently high for wiring in an automobile.
(4) The second sheath may be a foam.
Use of a foam as the second sheath allows the second sheath to be easily deformed. Further, when an external pressure is partially applied to the cable, the second sheath is able to collapse under the pressure to absorb the pressure.
(5) The plurality of coated electric wires may include coated electric wires having different conductor cross-sectional areas.
Use of the cable including the coated electric wires having different conductor cross-sectional areas allows the cable to be applicable to various applications.
(6) The plurality of coated electric wires may include two coated electric wires having a same conductor cross-sectional area, and the two coated electric wires may be twisted together.
The twisted-pair electric wire obtained by twisting two coated electric wires having the same conductor cross-sectional area can be used as an electric wire (signal wire) for signal transmission such as an electric wire for a sensor. The twisted-pair electric wire has the advantage of reducing deterioration and attenuation of the transmitted signal. In addition, the twisted-pair electric wire allows the two wires to be handled together when wired in the same place, thereby providing the advantage of easy wiring.
(7) In a cross-section perpendicular to the longitudinal direction, the roundness of the outer perimeter of the second sheath is 97% or more.
Setting the roundness of the outer perimeter of the second sheath to 97% or more allows the outer shape of the cable to be rounded. When the cable is inserted into another member such as a box, the round outer shape of the cable, that is, its nearly perfect circular shape, serves to suppress the occurrence of a gap between the cable and the inlet of the other member, thereby enabling the cable to be firmly fixed. In addition, the round outer shape of the cable allows for, when the cable is inserted into the housing of a device, easy sealing between the cable and the housing at the inlet, thereby preventing the occurrence of a gap between the cable and the housing.

### DETAILS OF EMBODIMENTS OF THE PRESENT DISCLOSURE

A specific example of a cable according to one embodiment of the present disclosure (hereinafter referred to as the “present embodiment”) will be described below with reference to the drawings. It should be noted that the present invention is not limited to these examples, but is intended to be illustrated by the scope of the claims and to include all modifications within the spirit and scope of equivalents of the claims.

### (1) Re: Members of the Cable

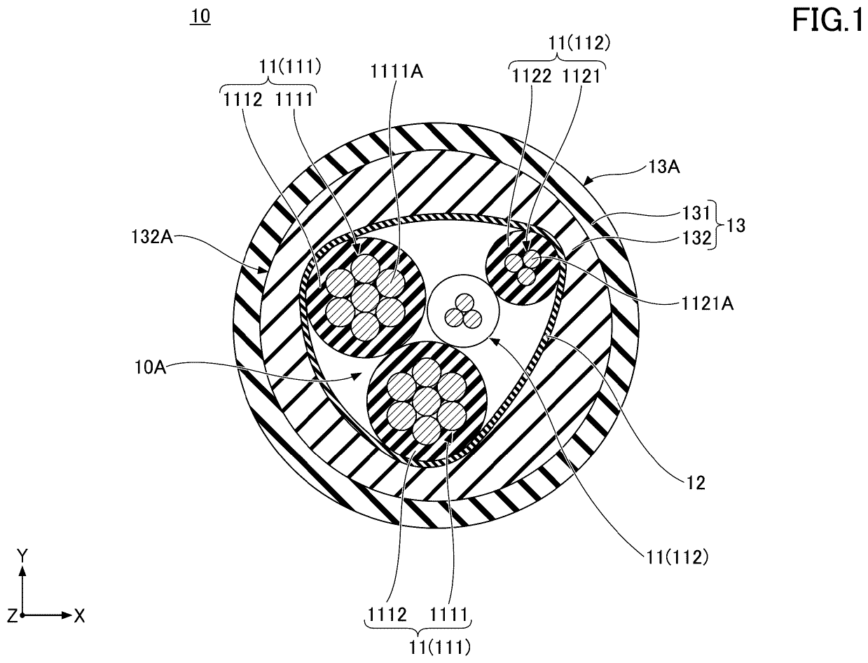

The cable of the present embodiment will first be described with reference to FIGS. 1 to 7B.

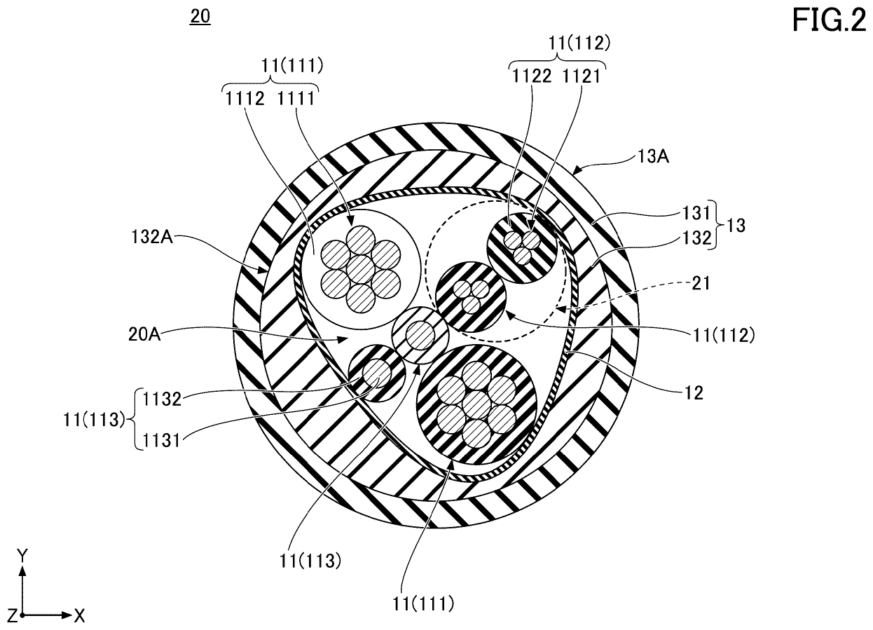

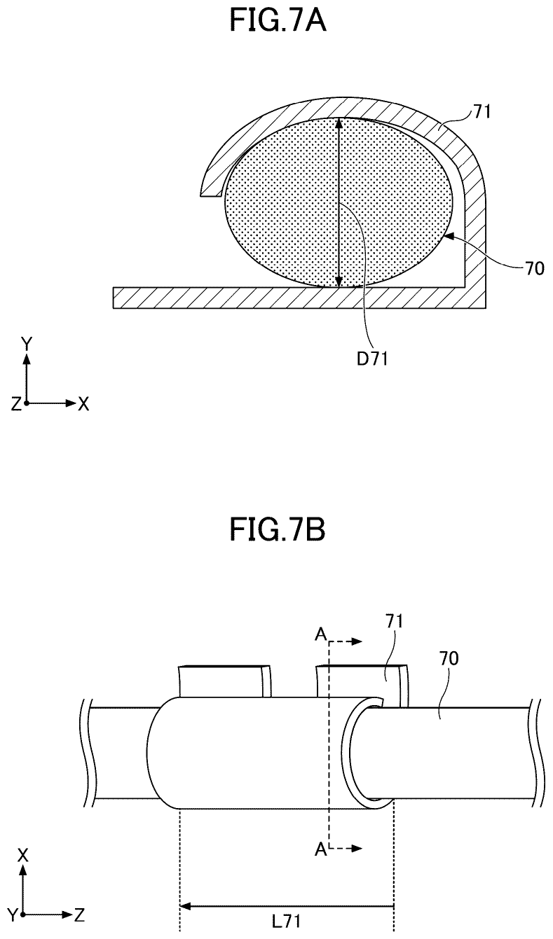

FIG. 1 illustrates a cross-sectional view of a cable 10 of the present embodiment in a plane perpendicular to the longitudinal direction. FIGS. 2 to 6 illustrate cross-sectional views of cables 20 to 60 of the present embodiment in a plane perpendicular to the longitudinal direction. Since FIGS. 2 to 6 are variations of the structure of the coated electric wires and sheath of the cable of the present embodiment, the cable of the present embodiment will be described mainly with reference to FIG. 1 and, if necessary, with reference to FIGS. 2 to 6. FIGS. 7A and 7B are illustrative views of a cable 70 of the present embodiment when fixed by a fixture 71. FIG. 7A is a sectional view taken along line A-A in FIG. 7B. In FIGS. 1-7B, the Z-axis direction is the longitudinal direction of the cable or the coated electric wires, and the XY plane is a cross-section perpendicular to the longitudinal direction of the cable or the like.

As illustrated in FIG. 1, the cable 10 of the present embodiment includes a plurality of coated electric wires 11 and a sheath 13 covering the plurality of coated electric wires 11.

Although the cable 10 illustrated in FIG. 1 is directed to an example having two first coated electric wires 111 and two second coated electric wires 112 as the coated electric wires 11, the configuration of the plurality of coated electric wires of the cable of the present embodiment is not limited to such a structure. The cable of the present embodiment may include any number of coated electric wires, and, also, the combination of the types of coated electric wires included in the cable may be selected as desired.

In the following, the members of the cable 10 of the present embodiment will be described.

### (1-1) Coated Electric Wires

The coated electric wires 11 are electric wires that performs functions required in equipment or the like, such as power supply, voltage application, communication, etc., and are electric wires for which wire breakage is to be suppressed. As described above, the number and configuration of the coated electric wires 11 are not limited to particular ones.

The coated electric wires 11 may each have a conductor and an insulator covering the outer lateral surface of the conductor. The conductor may be comprised of a plurality of conductor wires twisted together

The first coated electric wires 111 each includes a conductor 1111 which is a twisted bundle of conductor wires 1111A, and an insulator 1112 which covers the outer lateral surface of the conductor 1111. The first coated electric wires 111 may be, for example, power supply wires for supplying electric current.

The second coated electric wires 112 each includes a conductor 1121 which is a twisted bundle of conductor wires 1121A, and an insulator 1122 which covers the outer lateral surface of the conductor 1121. The second coated electric wires 112 may be, for example, signal wires for transmitting signals.

Like the first coated electric wires 111 and the second coated electric wires 112 in the cable 10 illustrated in FIG. 1, the cable of the present embodiment may include, as the plurality of coated electric wires 11, coated electric wires 11 having different conductor cross-sectional areas. Providing the coated electric wires 11 having different conductor cross-sectional areas in the cable as described above allows the cable to be usable in various applications. In the cable 10 of the present embodiment, the conductor cross-sectional area of the first coated electric wires 111 may be larger than that of the second coated electric wires 112.

In the case of the first coated electric wires 111, the conductor cross-sectional area of a coated electric wire 11 is the sum of the cross-sectional areas of the conductor wires 1111A constituting the conductor 1111.

In the case of the second coated electric wires 112, the sum of the cross-sectional areas of the conductor wires 1121A constituting the conductor 1121 is the conductor cross-sectional area.

The cable 10 illustrated in FIG. 1 is directed to an example in which the two first coated electric wires 111 and the two second coated electric wires 112 are provided as the coated electric wires 11, but such a configuration is not limiting. In the following, a description will be given of examples of the configuration of coated electric wires in other cables illustrated in FIGS. 2 to 5. The examples of the configuration of coated electric wires in the cables illustrated in FIGS. 2 to 5 are examples only, and these examples are not limiting.

### In the Case of Cable 20

The cable 20 illustrated in FIG. 2 includes two first coated electric wires 111, two second coated electric wires 112, and two third coated electric wires 113 as coated electric wires 11.

The third coated electric wires 113 each have a conductor 1131 and an insulator 1132 covering the conductor 1131.

FIG. 2 illustrates an example in which a single wire rather than a twisted wire is used as the conductor 1131 of each third coated electric wire 113, but this configuration is not limiting. A twisted wire obtained by twisting a plurality of conductor wires may alternatively be used as the conductor 1131.

In the cable 20 illustrated in FIG. 2, the plurality of coated electric wires 11 include the second coated electric wires 112 as two coated electric wires 11 having the same conductor cross-sectional area. The second coated electric wires 112 provided as such two coated electric wires 11 may be twisted together. That is, the second coated electric wires 112 may constitute a twisted-pair electric wire 21.

The twisted-pair electric wire obtained by twisting two coated electric wires 11 having the same conductor cross-sectional area may be used as a signal transmission wire (signal wire) such as a sensor wire. The twisted-pair electric wire has the advantage of reducing deterioration and attenuation of the transmitted signal. In addition, the twisted-pair electric wire allows two wires to be handled together when wired at the same place, thereby providing the advantage of easy wiring.

### In the Case of Cable 30

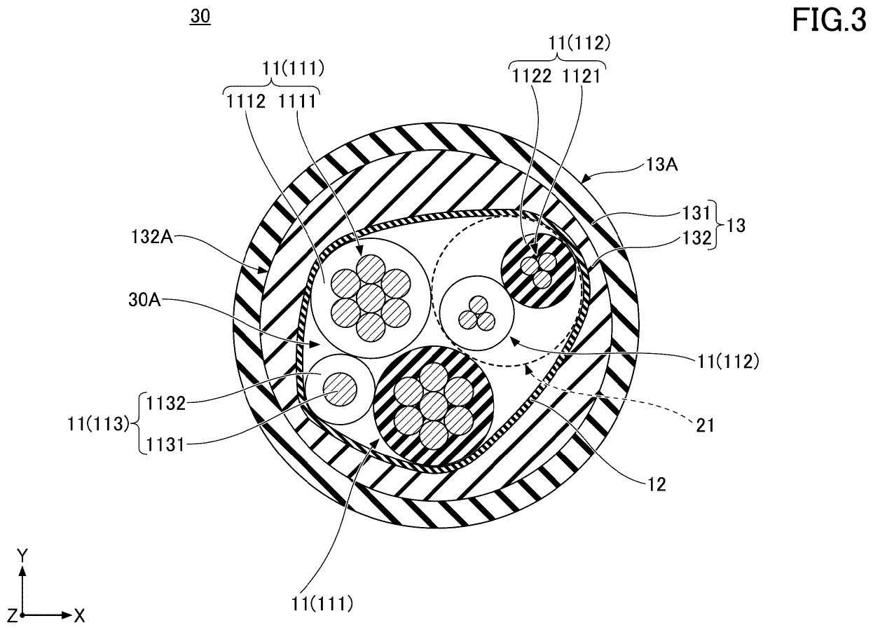

The cable 30 illustrated in FIG. 3 includes two first coated electric wires 111, two second coated electric wires 112, and one third coated electric wire 113 as the coated electric wires 11.

The cable 30 may have the same configuration as the cable 20 illustrated in FIG. 2 except that the number of third coated electric wires 113 is different.

In the case of Cable 40

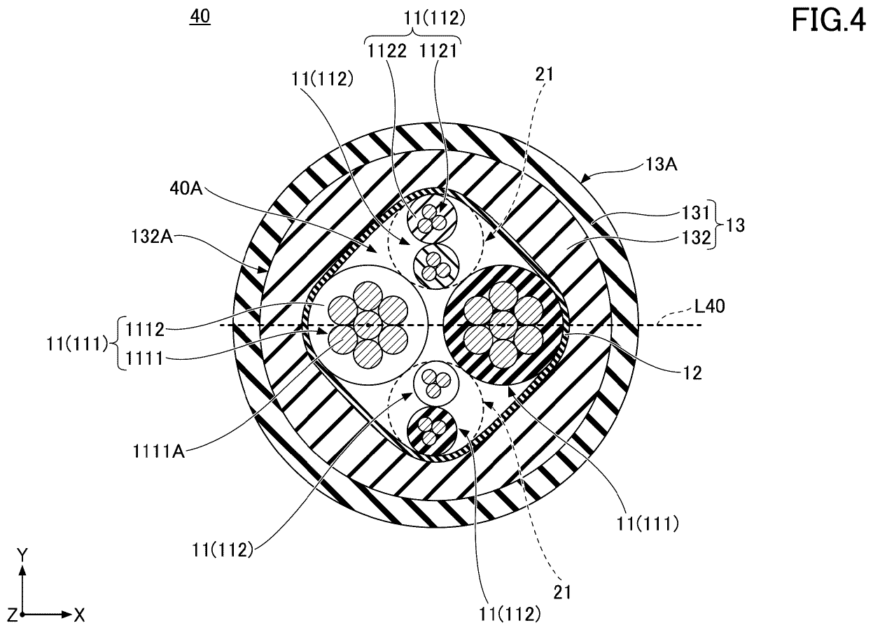

The cable 40 illustrated in FIG. 4 includes two first coated electric wires 111 and four second coated electric wires 112 as the coated electric wires 11.

In the cable 40 illustrated in FIG. 4, each pair of the four second coated electric wires 112 may be twisted together to form a twisted-pair electric wire 21. As illustrated in the cable 40, the cable of the present embodiment may be configured to include a plurality of pairs of twisted coated electric wires. In FIG. 4, the two twisted-pair electric wires 21 are arranged in symmetrical positions with an imaginary line L40 connecting the centers of the two first coated electric wires 111 as the axis of symmetry. With the above arrangement, the aggregate diameter of the coated electric wires 11 included in the cable 40 is made as small as possible, and the outer shape of the twisted coated electric wires 11 is made as round as possible.

### In the Case of Cable 50

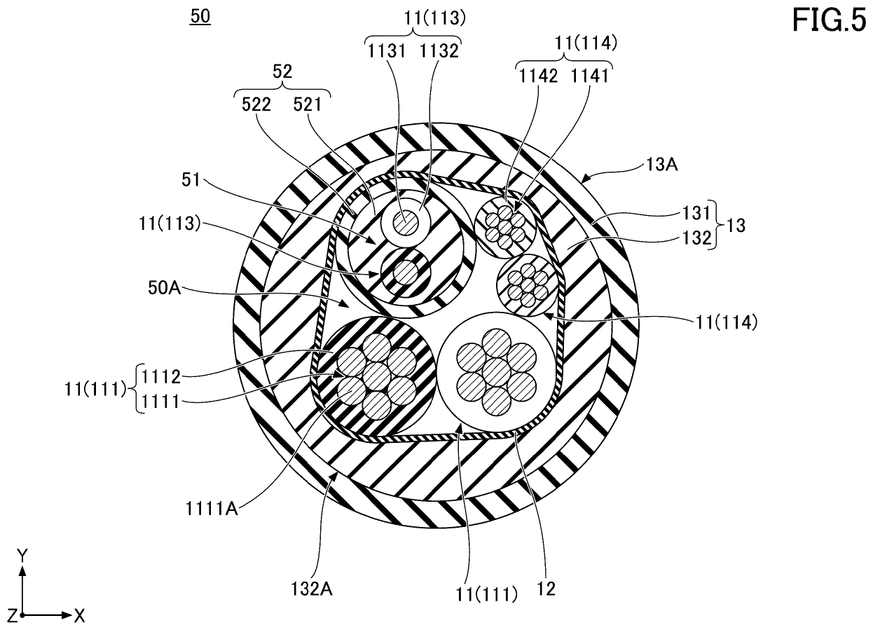

The cable 50 illustrated in FIG. 5 includes two first coated electric wires 111, two third coated electric wires 113, and two fourth coated electric wires 114 as the coated electric wires 11.

The fourth coated electric wires 114 each include a conductor 1141 which is a twisted bundle of conductor wires, and an insulator 1142 which covers the outer lateral surface of the conductor 1141.

The two third coated electric wires 113 having the same conductor cross-sectional area are twisted together to form a twisted-pair electric wire 51. A covering 52 may also be provided to cover the twisted-pair electric wire 51. FIG. 5 illustrates an example in which a first covering 521 and a second covering 522 are arranged in this order in a direction away from the twisted-pair electric wire 51 as a covering 52. The covering 52 may consist of one layer or more than three layers.

As the material of the first covering 521, one or more selected from, for example, thermoplastic polyurethane elastomer, ethylene-vinyl acetate copolymer (EVA), ethylene-ethyl acrylate copolymer (EEA), and the like may be suitably used.

As the material of the second covering 522, for example, a thermoplastic polyurethane elastomer or the like may be suitably used.

As illustrated in FIG. 5, the covering 52 may be made of an insulating resin covering the twisted-pair electric wire 51 by solid extrusion molding, and may be a resin tube (not shown).

### Example of Configuration of Coated Electric Wires

The diameter and number of conductor wires constituting a coated electric wire may be selected according to the electrical characteristics required for each coated electric wire.

For example, the diameter of conductor wires of the coated electric wires 11 is preferably from 0.05 mm to 0.16 mm, and more preferably from 0.05 mm to 0.10 mm. A power supply wire may be implemented as a conductor made by twisting conductor wires in multiple levels of hierarchy. In such an arrangement, for example, the conductor of the power supply wire may include first twisted wires (i.e., child twisted wires) each made by twisting conductor wires and a second twisted wire (i.e., parent twisted wire) made by twisting the first twisted wires. A third twisted wire made by further twisting a plurality of second twisted wires may also be used as the conductor. In this case, the first twisted wires may be referred to as grandchild twisted wires, and the second twisted wires may be referred to as child twisted wires, with the third twisted wire being referred to a parent twisted wire.

A signal wire may also be implemented as a conductor made by twisting conductor wires in multiple levels of hierarchy. That is, the conductor of a signal wire may include first twisted wires (i.e., child twisted wires) each made by twisting conductor wires and a second twisted wire (i.e., parent twisted wire) made by twisting the first twisted wires. The second twisted wire may be used as the conductor, and, alternatively, a third twisted wire made by twisting second twisted wires may be used as the conductor, for example. The conductor wires of the signal wire may each be twisted in a single level of hierarchy, and the first twisted wire may be used as the conductor.

The diameter of a wire element such as a conductor wire may be measured and derived by the following procedure, for example.

First, in a cross-section perpendicular to the longitudinal direction of a conductor wire, the diameter of the conductor wire is measured with a micrometer along two orthogonal diameters of the conductor wire. The average value may then be regarded as the diameter of the conductor wire. In this specification, the diameter of a conductor wire may be measured and derived in the same manner.

When the cable includes a power supply wire and a signal wire as the coated electric wires 11, an example configuration may be such that the cross-sectional area of a conductor of the power supply wire is from 1.5 mm² to 3.5 mm². In this case, an example configuration may be such that the cross-sectional area of a conductor of the signal wire is from 0.1 mm² to 0.5 mm².

Preferably, the cross-sectional area of the conductor of the power supply wire is larger than the cross-sectional area of the conductor of the signal wire. More preferably, the cross-sectional area of the conductor of the power supply wire is 3 to 15 times larger than the cross-sectional area of the conductor of the signal wire.

The material of a conductor wire of the coated electric wires 11 is not limited to a particular kind, but examples include copper, aluminum, copper alloy, aluminum alloy, and the like. The conductor wire may be plated with silver or tin on the surface. Because of this, silver plated copper alloy, tin plated copper alloy, or the like may be used as a material of the conductor wire.

Although the material of the insulator is not limited to a particular kind, one or more types of resin selected from fluororesin such as polytetrafluoroethylene (PTFE), tetrafluoroethylene-perfluoroalkyl vinyl ether copolymer (PFA), tetrafluoroethylene-hexafluoropropylene copolymer (FEP), ethylene-tetrafluoroethylene copolymer (ETFE), polyester resin such as polyethylene terephthalate (PET), polyolefin resin such as polyethylene, polypropylene, or the like may be used. The resin of the insulator may or may not be cross-linked.

In addition to the resin, the insulator may also contain additives such as a flame retardant, a flame-retardant aid, an antioxidant, a lubricant, a colorant, a reflective material, a concealing agent, a processing stabilizer, and a plasticizer.

### Core

The cable 10 may include a core 10A including the plurality of coated electric wires 11. The core 10A may be made by twisting together the plurality of coated electric wires 11, specifically, the two first coated electric wires 111 and the two second coated electric wires 112 along the longitudinal direction.

The cables 20 to 50 may also contain a core.

The cable 20 includes a core 20A formed by twisting together the two first coated electric wires 111, the two second coated electric wires 112, and the two third coated electric wires 113 in the longitudinal direction. The two second coated electric wires 112 are twisted together in advance as previously described.

The cable 30 includes a core 30A formed by twisting together the two first coated electric wires 111, the two second coated electric wires 112, and the one third coated electric wire 113 along the longitudinal direction. The two second coated electric wires 112 are twisted together in advance as previously described.

The cable 40 includes a core 40A formed by twisting together the two first coated electric wires 111 and the four second coated electric wires 112 along the longitudinal direction. The second coated electric wires 112 are twisted together in pairs in advance as previously described.

The cable 50 includes a core 50A formed by twisting together the two first coated electric wires 111, the two third coated electric wires 113, and the two fourth coated electric wires 114 along the longitudinal direction. The two third coated electric wires 113 are twisted together in advance as previously described.

The arrangement of the plurality of coated electric wires 11 constituting the core is not limited to a particular type. For example, the arrangement of coated electric wires may be selected such that the circumscribed circle of the plurality of coated electric wires 11 approaches a perfect circle in a cross-section perpendicular to the longitudinal direction of the cable.

The twist direction and twist pitch of the core are also not limited to particular ones, and may be selected as desired.

### (1-2) Sheath

The cable 10 may include the sheath 13 covering the plurality of coated electric wires.

When a cable is routed, the cable 70 may be secured to the vehicle body by the fixture 71, for example, as illustrated in FIGS. 7A and 7B. At this time, at a place where the fixture 71 secures the cable 70 as illustrated in FIGS. 7A and 7B, the cable 70 is clamped so that the short diameter D71 of the fixture 71 is shorter than the outer diameter of the cable 70 measured before fixing. Specifically, for example, clamping is performed such that the short diameter D71 of the fixture 71 becomes about 10% to 20% shorter than the outer diameter of cable 70 measured before fixing. In this manner, the cable 70 may be pressed by the fixture 71 and fixed in a deformed state. FIG. 7A illustrates a cross-section perpendicular to the longitudinal direction of the cable 70, and FIG. 7B is an axonometric view of the cable 70. In FIG. 7A, the illustration of the coated electric wires of the cable 70 is omitted. Further, the length L71 of the cable 70 (see FIG. 7B) in the longitudinal direction of the fixture 71 is usually selected to be, for example, about 1 to 3 times greater than the outer diameter of the cable 70.

A force may be applied to the cable 70 having been fixed by the fixture 71 as described above to repeatedly bend the cable 70. According to analysis performed by the inventor of the present invention, the bending force is likely concentrated in that part of the cable 70 which is fixed by the fixture 71. As a result, breakage is likely to occur at the part fixed by the fixture 71.

Upon further analysis performed by the inventor of the present invention, it is found that wire breakage can be suppressed by providing the sheath 13 with at least a two-layer structure including an easily-deformable layer that absorbs the external force applied during bending to reduce the force applied to the plurality of coated electric wires 11, resulting in the completion of the present invention.

### Structure of Sheath

The sheath 13 of the cable 10 of the present embodiment includes a first sheath 131 and a second sheath 132 arranged in this order in a direction away from the outer surface 13A.

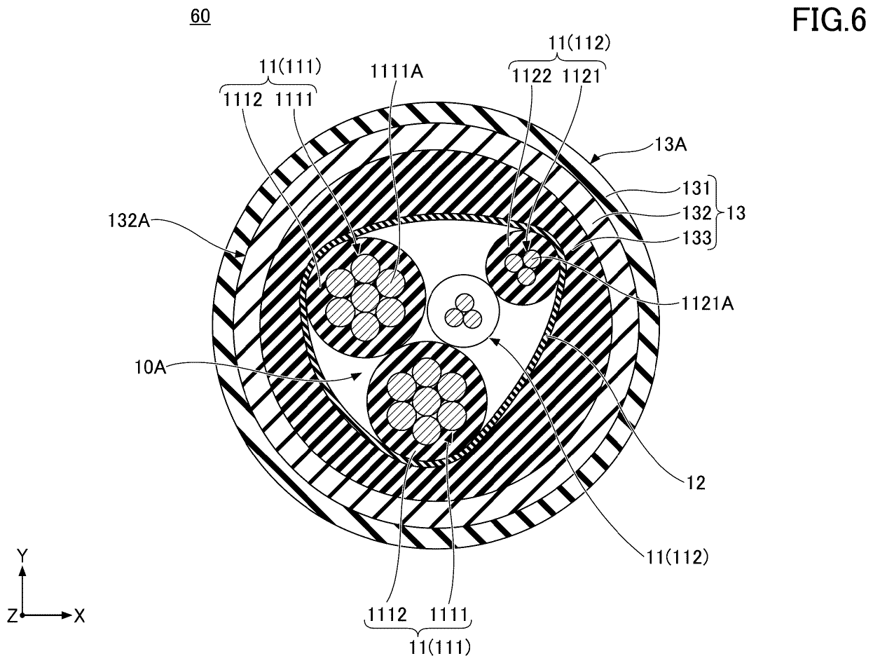

The first sheath 131 is a layer including the outer surface 13A of the sheath 13, and is a layer arranged on the outermost side. The second sheath 132 is a layer arranged further toward the core 10A than the first sheath 131. The sheath 13 is not limited to a structure having only two layers, i.e., the first sheath 131 and the second sheath 132, and may be composed of three or more layers. The sheath 13 may include, for example, a third sheath 133 (see the cable 60 in FIG. 6) or the like situated further toward the core 10A than the second sheath 132.

The elastic modulus of the second sheath 132 of the sheath 13 is made smaller than that of the first sheath 131.

By reducing the elastic modulus of the second sheath 132 located on the inner peripheral side of the sheath 13 to a smaller value than that of the first sheath 131 located on the outer peripheral side, the second sheath 132 can deform and absorb the force even when the cable 10 is subjected to force and repeatedly bent. This arrangement enables the reduction of the force applied to the plurality of coated electric wires 11 by bending, thereby suppressing the breakage of the coated electric wires 11 even when the cable 10 is repeatedly bent.

The sheath 13 has the function to protect the coated electric wires 11 inside the cable 10. The sheath 13 includes at least two layers, i.e., the first sheath 131 and the second sheath 132, as described above, and the second sheath 132 functions as a layer for absorbing the force applied to the cable, thereby allowing the elastic modulus of the first sheath 131 to be increased to enhance the mechanical strength of the cable 10. Cables wired to automobiles are required to have abrasion resistance against abrasion with the vehicle body, scratch resistance that prevents scratching even when hit by stepping stones, etc., and bending resistance that ensures less deterioration even when repeatedly bent. These requirements can be met by increasing the mechanical strength of the sheath 13.

In this specification, elastic modulus refers to tensile elastic modulus measured at 23° C.

In the following, each layer of the sheath 13 will be described.

### First Sheath

It suffices for the elastic modulus of the first sheath 131 to be larger than that of the second sheath 132. Although not limited to a particular value, the elastic modulus of the first sheath 131 is preferably from 33 MPa to 55 MPa.

Setting the elastic modulus of the first sheath 131 to 55 MPa or less allows the cable 10 to have flexibility suitable for wiring in an automobile.

Setting the elastic modulus of the first sheath 131 to 33 MPa or more allows the mechanical strength of the first sheath 131 to be sufficiently high for wiring in an automobile.

Although the material of the first sheath 131 is not limited to a particular kind, the first sheath 131 may contain, for example, a thermoplastic polyurethane elastomer. The resin of the first sheath 131 may or may not be cross-linked.

In addition to the resin, the first sheath 131 may also contain additives such as a flame retardant, a flame-retardant aid, an antioxidant, a lubricant, a colorant, a reflective material, a concealing agent, a processing stabilizer, and a plasticizer.

### Second Sheath

As described above, the elastic modulus of the second sheath 132 may be smaller than that of the first sheath 131.

The elastic modulus of the second sheath 132 is preferably 40% to 80% of the elastic modulus of the first sheath 131, for example. This range of elastic modulus may be realized by using a material having an elastic modulus within this range or by adjusting the degree of foaming of the second sheath.

Setting the elastic modulus of the second sheath 132 to 80% or less of the elastic modulus of the first sheath 131 allows the cable 10 to possess an increased flexibility. When the cable 10 is subjected to force and repeatedly bent, thus, the force applied to the cable 10 can be absorbed, which prevents the coated electric wires 11 from breaking.

Setting the elastic modulus of the second sheath 132 to 40% or more of the elastic modulus of the first sheath 131 allows the second sheath 132 to be manufactured by extrusion molding. This increases the productivity of the cable 10 and reduces the cost.

Although the material of the second sheath 132 is not limited to a particular kind, the second sheath 132 may contain, for example, a thermoplastic polyurethane elastomer, and may specifically contain a foamed thermoplastic polyurethane elastomer. The resin of the second sheath 132 may or may not be cross-linked.

In addition to the resin, the second sheath 132 may also contain additives such as a flame retardant, a flame-retardant aid, an antioxidant, a lubricant, a colorant, a reflective material, a concealing agent, a processing stabilizer, and a plasticizer.

The second sheath 132 may also be a foam.

Use of a foam as the second sheath 132 allows the second sheath 132 to be easily deformed. When an external pressure is partially applied to the cable 10, the second sheath 132 is able to collapse under the pressure and absorb the pressure.

The roundness of the outer perimeter 132A of the second sheath 132 in a cross-section perpendicular to the longitudinal direction of the cable 10 is not limited to a particular value, but is preferably 97% or more.

Setting the roundness of the outer perimeter 132A of the second sheath 132 to 97% or more allows the outer shape of the cable 10 to be rounded, for example, to a substantially perfect circle. When the cable 10 is inserted into a separate member such as a box, the round outer shape of the cable 10, that is, its nearly perfect circular shape, serves to suppress the occurrence of a gap between the cable 10 and the inlet of the separate member, which allows the cable 10 to be firmly fixed. Further, the round outer shape of the cable 10 allows for, when the cable 10 is inserted into the housing of a device, easy sealing between the cable and the housing at the inlet, thereby preventing the occurrence of a gap between the cable and the housing.

The method of making the roundness of the outer perimeter 132A of the second sheath 132 fall within the above-noted range is not limited to a particular kind. Examples of the method include the method of providing the third sheath 133 as will be described below and the method of making the second sheath 132 sufficiently thick and adjusting the roundness of the second sheath 132.

The roundness is measured by deriving the ratio of diameters in two orthogonal directions in a cross-section perpendicular to the longitudinal direction of the cable. The roundness of the outer perimeter 132A of the second sheath 132 is preferably an average value of roundness calculated over a plurality of cross-sections by taking measurements in each of the plurality of cross-sections perpendicular to the longitudinal direction of the cable.

For example, in the cross-section of the cable 10 illustrated in FIG. 1, the outer diameter of the second sheath 132 is measured along the X axis and the Y axis. The roundness of the outer perimeter 132A of the second sheath 132 at this cross-section is calculated as the ratio between the outer diameter along the X axis and the outer diameter along the Y axis. The roundness of the outer perimeter 132A of the second sheath 132 is calculated in the same manner with respect to additional cross-sections. The average value of the measured roundness over the plurality of cross-sections may then be used as the roundness of the outer perimeter 132A of the second sheath 132 of the cable. When measuring the roundness at the plurality of cross-sections as described above, the directions of the X and Y axes preferably remain the same. That is, evaluation is preferably made by the above-noted procedure while the XYZ axes are fixed over the entire length of the cable 10 to be measured.

The distance between the cross-sections to be evaluated is preferably constant. The number of cross-sections to be evaluated is not limited to a particular value, and is preferably 3 or more, for example.

The roundness is, for example, more preferably from 97% to 103%.

### Third Sheath

As previously described, the sheath 13 may include not only two layers, i.e., the first sheath 131 and the second sheath 132, but also 3 or more layers. For example, the sheath 13 may include the third sheath 133. In the case in which the sheath 13 has the third sheath 133, the third sheath 133 may be positioned further toward the core 10A than the second sheath 132, for example, as illustrated in FIG. 6. As the cable 60 illustrated in FIG. 6 has the same structure as the cable 10 illustrated in FIG. 1 except that the sheath 13 includes the third sheath 133, the description of other aspects will be omitted.

Provision of the third sheath 133 in the sheath 13 serves to improve the roundness of the cable.

Although the material of the third sheath 133 is not limited to a particular kind, the material may include one or more kinds of resin selected from polyolefin-based resins such as thermoplastic polyurethane elastomer (TPU), ethylene-vinyl acetate copolymer resin (EVA), and ethylene-ethyl acrylate copolymer resin (EEA). The resin of the third sheath 133 may or may not be cross-linked.

In addition to the above-noted resin, the third sheath 133 may also contain additives such as a flame retardant, a flame-retardant aid, an antioxidant, a lubricant, a colorant, a reflective material, a concealing agent, a processing stabilizer, and a plasticizer.

### (1-3) Holding Winding

The cable 10 of the present embodiment may also include the holding winding 12 covering the outer lateral surface of the core 10A. Preferred examples of the holding winding 12 include a tape helically wound around the outer lateral surface of the core 10A along the longitudinal direction of the core 10A, which tape is composed of an insulating material such as paper, a nonwoven fabric, or a resin such as polyester.

Arranging the holding winding 12 around the outer lateral surface of the core 10A prevents the direct contact between the core 10A and the sheath 13. The sheath 13 may thus be easily detached from the core 10A when the coated electric wires 11 are exposed at the longitudinal end of the cable 10.

When the holding winding 12 is formed by winding a tape around the outer lateral surface of the core 10A as described above, the winding direction of the holding winding 12 may be selected as desired. For example, the direction may be the same direction as the twist direction of the core 10A previously described, or may be a different direction. It is particularly preferable that the twist direction of the core 10A and the winding direction of the holding winding 12 are in the same direction.

The winding pitch of the holding winding 12 is preferably shorter than the twist pitch of the core 10A. This is because, by making the winding pitch of the holding winding 12 shorter than the twist pitch of the core 10A, the tape forming the holding winding 12 is prevented from falling into the recess formed between the plurality of coated electric wires 11 constituting the core 10A, which serves to smoothen the surface of the holding winding 12.

### (1-4) Interposition

The cable 10 of the present embodiment may also include an interposition disposed within an area enclosed by the sheath 13, for example, within the core 10A. The interposition may be made of fibers such as staple fiber thread or nylon thread. The interposition may be made of high tensile strength fibers.

Arranging the interposition in the core 10A, for example, between the coated electric wires 11, allows the arrangement of the coated electric wires 11 to be adjusted, thereby allowing the shape of the circumscribed circle of the core 10A and the outer surface of each layer constituting the sheath 13 to be adjusted in a cross-section perpendicular to the longitudinal direction of the cable 10, thereby readily making the shape closer to a perfect circle.

The cable of the present embodiment may be used for various applications in which the cable is subjected to a force and may repeatedly be bent. The cable of the present embodiment is suitable for use in a device such as an automobile whose motion causes the cable to be subjected to frequent bending and vibration, such as an electric parking brake in which the parking brake is implemented as an electric system. In particular, the cable may be suitably used in an application in which the consequence of breakage of a coated electric wire is significant, and, thus, it is specifically required to suppress the breaking of the coated electric wire, as in an electric brake system in which the foot brake of an automobile is implemented as an electric system. In the electric brake system, the power supply lines are configured to supply electric power to drive the motor, and the signal lines are configured to transmit electric signals related to the control of the motor and electric signals related to the rotational speed of the wheels.

### (2) Evaluation Method

Evaluation methods for the cable of the present embodiment will be described below.

### (2-1) Elastic Modulus

A method of evaluating the elastic modulus of the sheath of a cable will be described.

First, the first sheath and the second sheath are individually cut off from the cable to be evaluated. When the sheath 13 includes a third sheath, the third sheath may be removed in the same manner. At this time, each layer is carefully cut so that the entire thickness of each layer is retained to the extent possible.

Then, each cut-off sheath is used to make a specimen for measuring tensile modulus in accordance with ISO527. Preferably, the specimen for measuring tensile modulus is as thick as can be cut from the cable. The width and length of the specimen shall maintain a gauge length of 50 mm and a width of 10 mm, and the other dimensions shall be the same as values defined in the standard, or as close as possible to the values defined in the standard.

The 0.25% secant modulus at 23° C. is measured for the prepared specimen, and the tensile modulus for the specimen is determined.

### (2-2) Bendability

The following procedure may be used to evaluate the flex life of the cable, i.e., the degree to which the breakage of a coated electric wire is prevented in the cable when the cable is repeatedly bent.

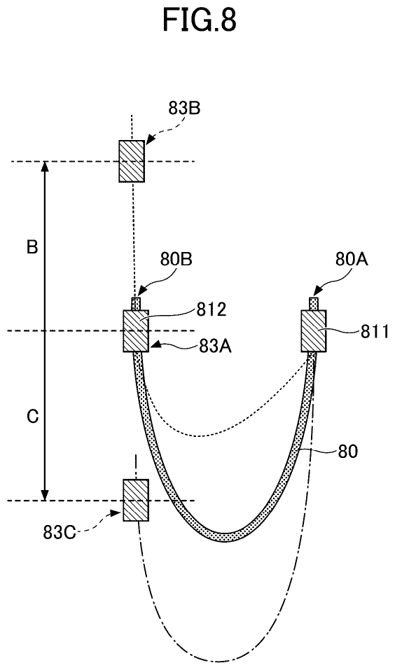

As illustrated in FIG. 8, the first end portion 80A of a cable 80 to be evaluated is gripped and secured by a first blanket 811. The first blanket 811 is fixed in place to prevent movement thereof during the flex-life test.

The second blanket 812 grips the second end portion 80B of the cable 80. The blankets are installed such that the cable 80 between the first blanket 811 and the second blanket 812 is set to 200 mm. The second end portion 80B of the cable 80 gripped by the second blanket 812 is allowed to be movable in the vertical direction.

The second blanket 812 is moved up and down in the vertical direction from a reference position 83A along the arrows B and C in FIG. 8 to repeatedly bend the cable 80. The reference position 83A is located at the same height as the first blanket 811. When the first blanket 811 and the second blanket 812 are at the reference position, the distance between these two is 100 mm.

The bending is repeatedly performed by moving the second blanket 812 from the reference position 83A to an upper end 83B, to the reference position 83A, to a lower end 83C, and to the reference position 83A as one round. In this operation, the upper end 83B and the lower end 83C may be switched in order.

Arrangement is made such that the distance between the reference position 83A and the upper end 83B and the distance between the reference position 83A and the lower end 83C are equal to each other, and remain constant even after repeated bending. When the length of the cable 80 between the first blanket 811 and the second blanket 812 is 200 mm, the distance from the reference position to the upper end or the lower end should be 80 mm.

The above-noted operation of repeatedly bending the cable 80 is performed while measuring the resistance values of the conductors of all the coated electric wires 11 in the cable 80. Then, when the resistance becomes 10 or more times the initial resistance value for any of the conductors of the coated electric wires 11, the number of bends made so far is recorded, and is used as an index value for the flex-life test.

The greater the index value for the flex-life test, that is, the higher the number of bends, the better the flex life is.

### (3) Example of Cable Manufacture

An example of cable manufacture will be described below. It should be noted that the present invention is not limited to the following examples.

Since the manufactured cable has the same structure as the cable 60 illustrated in FIG. 6 except that the two second coated electric wires 112 are twisted together, the description will be made with reference to FIG. 6.

The core 10A includes the two first coated electric wires 111 and the two second coated electric wires 112.

The first coated electric wires 111 each include the conductor 1111 which is made by twisting the conductor wires 1111A together, and the insulator 1112 which covers the outer lateral surface of the conductor 1111. The diameter of the conductor wire 1111A is 0.08 mm, and the cross-sectional area of the conductor 1111 is 1.7 mm². The insulator 1112 is made of polyethylene, and has an outer diameter of 2.7 mm.

The second coated electric wires 112 each include the conductor 1121 which is made by twisting the conductor wires 1121A together, and the insulator 1122 which covers the outer lateral surface of the conductor 1121. The diameter of the conductor wire 1121A is 0.08 mm, and the cross-sectional area of the conductor 1121 is 0.24 mm². The insulator 1122 is made of polyethylene, and has an outer diameter of 1.5 mm.

The two first coated electric wires 111 and the two second coated electric wires 112 are twisted together to form the core 10A. As described above, the two second coated electric wires 112 are twisted together in advance, unlike the case illustrated in FIG. 6.

A tape is wound around the outer lateral surface of the core 10A to form the holding winding 12, and the sheath 13 is arranged to cover the outer lateral surface of the holding winding 12.

The sheath 13 includes the first sheath 131, the second sheath 132, and the third sheath 133 in this order from the side with the outer surface 13A.

The first sheath 131 is made of a thermoplastic polyurethane elastomer. The thickness of the first sheath 131 is 0.2 mm. The tensile modulus at 23° C., which is the elastic modulus of the thermoplastic polyurethane elastomer of the first sheath 131, was 50 MPa.

The second sheath 132 is made of a foamed thermoplastic polyurethane elastomer, and the thickness of the second sheath 132 is 0.5 mm. The second sheath is made of the same resin as the first sheath, but differs in that a foamed structure is used. The elastic modulus of the second sheath was 50% of that of the first sheath.

The third sheath 133 is made of the same thermoplastic polyurethane elastomer as the first sheath 131. The thickness of the third sheath 133 was 0.3 mm.

When the above cable is subjected to the flex-life test described above, the number of bends exceeds 300,000, resulting in a cable with excellent flex life, that is, a cable for which wire breakage is suppressed even when repeatedly bent.

### DESCRIPTION OF THE CODE

10, 20, 30, 40, 50, 60, 70, 80 cable
10A, 20A, 30A, 40A, 50A core
11 coated electric wire
111 first coated electric wire
112 second coated electric wire
113 third coated electric wire
114 fourth coated electric wire
1111A, 1121A conductor wire
1111, 1121, 1131, 1141 conductor
1112, 1122, 1132, 1142 insulator
12 holding winding
13 sheath
131 first sheath
132 second sheath
132A outer perimeter
133 third sheath
13A outer surface
21, 51 twisted-pair electric wire
L40 imaginary line
52 covering
521 first covering
522 second covering
71 fixture
D71 short diameter
L71 length
80A first end portion
80B second end portion
811 first blanket
812 second blanket
83A reference position
83B upper end
83c lower end
B, C arrow

1. A cable comprising:
a plurality of coated electric wires; and
a sheath covering the plurality of coated electric wires,
wherein the sheath includes a first sheath and a second sheath in order from an outer surface side of the sheath,
wherein the second sheath has a smaller elastic modulus than the first sheath, and
wherein elastic modulus refers to tensile elastic modulus measured at 23° C.

2. The cable as claimed in claim 1, wherein the elastic modulus of the second sheath is 40% to 80% of the elastic modulus of the first sheath.

3. The cable as claimed in claim 1, wherein the first sheath has an elastic modulus of 33 MPa to 55 MPa.

4. The cable as claimed in claim 1, wherein the second sheath is a foam.

5. The cable as claimed in claim 1, wherein the plurality of coated electric wires include coated electric wires having different conductor cross-sectional areas.

6. The cable as claimed in claim 1, wherein the plurality of coated electric wires include two coated electric wires having a same conductor cross-sectional area, and the two coated electric wires are twisted together.

7. The cable as claimed in claim 1, wherein in a cross-section perpendicular to a longitudinal direction, a roundness of an outer perimeter of the second sheath is 97% or more.
